(19) United States
(12) Patent Application Publication
(10) Pub. No.: US 2023/0196406 A1
(43) Pub. Date: Jun. 22, 2023

(54) SIAMESE NEURAL NETWORK MODEL

(71) Applicant: THE TORONTO-DOMINION BANK, Toronto (CA)

(72) Inventors: OLIVIER GANDOUET, MONTREAL (CA); GHAITH KAZMA, LAVAL (CA); MOULOUD-BEALLAH BELBAHRI, LAVAL (CA)

(21) Appl. No.: 18/086,513

(22) Filed: Dec. 21, 2022

Related U.S. Application Data
(60) Provisional application No. 63/292,148, filed on Dec. 21, 2021.

(51) Int. Cl. G06Q 30/0251; G06Q 30/0202

(52) U.S. Cl. CPC G06Q 30/0253; G06Q 30/0202

(57) ABSTRACT

Methods, apparatus and techniques are provided for a twin neural model for uplift. The methods include obtaining a dataset corresponding to a prediction task; performing, via a randomizer, a random selection of whether to apply an artificial neural network comprising a Siamese neural network to the dataset or whether to perform a random prediction for the prediction task; determining subsequent to the random selection of the randomizer, a gathered outcome for each prediction scenario based on applying or not applying the model to the dataset including a difference between the gathered outcome for each scenario; and, feeding back the gathered outcome and the difference to retrain the Siamese neural network model for use in performing the prediction task.

### CROSS-REFERENCE TO RELATED APPLICATIONS

This application claims the benefit of U.S. Provisional Patent Application No. 63/292,148, filed on Dec. 21, 2021, entitled “SIAMESE NEURAL NETWORK MODEL FOR USE IN MAXIMIZING THE EFFICIENCY OF MARKETING CAMPAIGNS”, the entire contents of which are incorporated herein by reference.

### FIELD

The present disclosure relates to computer-implemented systems and methods using artificial neural networks and particularly, a Siamese neural network model and methods for optimizing and re-training same.

### BACKGROUND

Uplift is a particular case of conditional treatment effect modeling. Such models deal with cause-and-effect inference for a specific factor, such as a digital marketing intervention. In practice, these models are built on individual data from randomized trials where the goal is to partition the participants into heterogeneous groups depending on the uplift. Most existing approaches are adaptations of random forest for the uplift case. Several split criteria rely on maximizing heterogeneity. Other tree-based methods for uplift overfit the training data and thus predicting uplift still lacks satisfactory solutions. These approaches are generally prone to overfitting and inaccuracies.

Analyses in the field of computerized digital marketing, such as for e-commerce websites are helpful to determine the success of a particular treatment, such as displaying a digital marketing content and how to present the e-commerce content.

At present, computer-implemented analytic methods are ineffective at performing a prediction task, such as a potential effect of a particular treatment or action thereby resulting in an inefficient use of computer technology and inaccurate results. Examples of such treatments may include whether to perform digital marketing interventions or display e-commerce content presented on networked computer systems. One example of these computer-implemented methods includes likelihood-based methods, which employ modification of regression equations and require a number of manual manipulations in order to optimize the model. Another example of these computer-implemented methods includes tree-based methods, which capture non-linear patterns but does not perform well in determining individual outcome predictions. There is thus need for an improved uplift modelling technique.

There is therefore a need for an effective, real-time, automated, powerful, flexible, and accurate computer implemented method and system for maximizing efficiency of predictions such as for computerized individual treatment effect modelling predictions.

### SUMMARY

In at least one aspect, it is an object of the disclosure to provide a twin neural network architecture prediction model for individual treatment effect modelling. In some implementations, such a model includes a Siamese-based prediction model that is able to predict the success of a targeted treatment such as a digital marketing campaign presented on a display of a computing device to an individual customer from a set of customers based on data derived from simulations where both the customer was targeted and the customer was not targeted.

In at least one aspect, a computing device is provided for assessing the efficacy of a proposed treatment, the computing device comprising a processor, a storage device and a communication device where each of the storage device and the communication device is coupled to the processor, the storage device storing instructions which when executed by the processor, configure the computing device to: receive a set of inputs comprising an information bank detailing specific information in relation to one or more targets of the proposed treatment, this information bank or data storage containing the results of a prior trial whereby some of the targets who are included in the information bank have already received the proposed treatment, and their response to said treatment is included in the information bank; run a simultaneous simulation whereby the set of inputs are identically fed into a set of two tracks with the exception of one variable added to one track and not the other, this simulation also including a third track that represents the truth, or whether the target had received the treatment in the trial and how they responded to the treatment; automatically predict, using a Siamese-based machine learning model, an uplift assessment based on uplift modelling of a difference in output between the two tracks; and, in response to the uplift assessment generate, in real-time, a determination of whether the proposed treatment would have an expected effect on the target of the proposed treatment.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method comprising executing on a processor steps comprising: obtaining a dataset corresponding to a prediction task; performing, via a randomizer, a random selection of whether to apply an artificial neural network which includes a Siamese neural network model to the dataset or whether to perform a random prediction for the prediction task; determining subsequent to the random selection of the randomizer, a gathered outcome for each prediction scenario based on applying or not applying the model to the dataset including a difference between the gathered outcome for each scenario; and feeding back the gathered outcome and the difference to retrain the Siamese neural network model for use in performing the prediction task. Other embodiments of this aspect include corresponding computer systems, apparatus, and computer programs recorded on one or more computer storage devices, each configured to perform the actions of the methods.

Implementations may include one or more of the following features. The method where feeding back the gathered outcome further may include performing a comparison of whether the gathered outcome aligns with a predefined expected outcome for applying or not applying the model as previously used to train the Siamese neural network model. The method further may include determining a performance comparison between prediction outputs generated by the randomizer and prediction outputs generated by applying the model to the dataset to perform a comparison of each of their performances (e.g. versus actual outcomes such as whether the prediction actually occurred or not) as compared to one another to determine which of the random prediction or model prediction outperforms and feeding such result further for retraining the model in a subsequent iteration. The method may include, further obtaining output data from the retrained model as input data to the randomizer for applying the retrained model in a subsequent iteration of the randomizer when the random selection indicates applying the model and generating a further gathered outcome to further retrain the model. The dataset may include data obtained from a data warehouse and online data obtained from at least one website operating web content displays in response to the prediction task. The Siamese neural network model performs the prediction task and further may include: receiving a set of inputs from an information bank detailing specific information in relation to one or more targets of a proposed treatment, this information bank containing results of a prior trial where some of the targets who are included in the information bank have already received the proposed treatment, and their response to said proposed treatment is included in the information bank; executing a simultaneous simulation where the set of inputs are identically fed into a set of two tracks with an exception of one variable added to one track and not the other, this simulation also including a third track that represents a truth characterizing whether a particular target had received the proposed treatment in the trial and a corresponding response to the treatment; automatically predicting, using the Siamese neural network, an uplift assessment based on uplift modelling of a difference in output between the two tracks; and, in response to the uplift assessment generating, in real-time, a determination of whether the proposed treatment would have an expected effect on the particular target of the proposed treatment. The prediction task may include whether to trigger a computing device to display information on an e-commerce website relating to a particular product offered on the e-commerce website and each Siamese neural network model is trained configured to perform a prediction for each type of product. The prediction task may include whether to trigger a computing device to place an automated call relating to a particular product offered on an e-commerce website. The randomizer is performed by using a network shared across multiple prediction tasks. One or more inputs to the dataset are randomly selected by the randomizer. Implementations of the described techniques may include hardware, a method or process, or computer software on a computer-accessible medium.

One general aspect includes a computing device including a processor and a memory storing instructions that when executed by the processor cause the computing device to obtain a dataset corresponding to a prediction task; perform, via a randomizer, a random selection of whether to apply an artificial neural network including a Siamese neural network model to the dataset or whether to perform a random prediction for the prediction task; determine subsequent to the random selection of the randomizer, a gathered outcome for each prediction scenario based on applying or not applying the model to the dataset including a difference between the gathered outcome for each scenario; and, feed back the gathered outcome and the difference to retrain the Siamese neural network model for use in performing the prediction task. Other embodiments of this aspect include corresponding computer systems, apparatus, and computer programs recorded on one or more computer storage devices, each configured to perform the actions of the methods.

Implementations may include one or more of the following features. The computing device where the instructions cause the computing device to further obtain output data from the retrained model as input data to the randomizer for applying the retrained model in a subsequent iteration of the randomizer when the random selection indicates applying the model and generating a further gathered outcome to further retrain the model. The memory communicatively coupled to the processor is configured for storing the gathered outcome, the difference and the output data from the retrained model. Implementations of the described techniques may include hardware, a method or process, or computer software on a computer-accessible medium.

One general aspect includes a computer program product comprising a non-transient storage device storing instructions that when executed by at least one processor of a computing device, configure the computing device to: obtain a dataset corresponding to a prediction task; perform, via a randomizer, a random selection of whether to apply an artificial neural network, which includes a Siamese neural network model, to the dataset or whether to perform a random prediction for the prediction task; determine subsequent to the random selection of the randomizer, a gathered outcome for each prediction scenario based on applying or not applying the model to the dataset including a difference between the gathered outcome for each scenario; and feed back the gathered outcome and the difference to retrain the Siamese neural network model for use in performing the prediction task. Other embodiments of this aspect include corresponding computer systems, apparatus, and computer programs recorded on one or more computer storage devices, each configured to perform the actions of the methods.

A non-transitory computer readable medium having stored thereon computer program code that is executable by a processor and that, when executed by the processor, causes the processor to perform the method of any of the foregoing aspects or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

These and other features will become more apparent from the following description in which reference is made to the appended drawings wherein:

FIG. 1A is a schematic block diagram of an example computing architecture and example method for an improved twin neural network model for prediction, including providing an assessment of the efficacy of a proposed treatment in accordance with one or more aspects of the present disclosure.

FIG. 1B is a graphical representation of the uplift interaction model and a neural network representation of the uplift model, according to one or more aspects of the present disclosure.

FIG. 2 is a graphical representation of a twin logistic interaction model, according to one or more aspects of the present disclosure.

FIG. 3 is a graphical representation of a twin neural model for uplift, according to one or more aspects of the present disclosure.

FIG. 4 is a block diagram illustrating an example computing device for providing an assessment of the efficacy of a proposed treatment by applying a Siamese neural network model, in accordance with one or more aspects of the present disclosure.

FIG. 5 shows an example implementation of a Siamese predictive model such as a Siamese model for individual treatment effect (SMITE) in accordance with an embodiment of the present disclosure.

FIG. 6 shows an example implementation of a Siamese predictive model such as a Siamese model for individual treatment effect (SMITE) in accordance with a further embodiment of the present disclosure.

### DETAILED DESCRIPTION

Machine learning models may be used in analyzing a possible treatment effect such as a digital marketing content as they can employ predictive algorithms to determine whether tweaks to e-commerce offerings or actions will be successful in the future.

Most prior models in the field of predicting optimization are either likelihood-based (modification of regression), or else tree-based (capturing non-linear patterns). While both of these models have unique advantages, neither are properly suited to the task and therefore do not give useful results. Existing models are also prone to overfitting issues in that they do not perform well on unseen data and therefore inaccurate. Other prior computerized methods are difficult to train and require manual manipulations.

The proposed disclosure discloses, in at least some aspects, a particular Siamese model for individual treatment effect which is a neural network based uplift model providing flexible and powerful prediction and is automated in that very minimal or no data preparation is needed.

In at least some embodiments, the disclosed Siamese model, also referred to as SMITE herein (Siamese model for individual treatment effect) has a unique computing architecture in that it draws inferences based on a Siamese prediction model and applies these inferences to optimization of a specific factor, such as digital marketing optimization, or other factors. For example, such digital marketing optimizations may include, in some aspects, triggering computing devices as to whether or not to display particular digital content relating to e-commerce products on websites based on the prediction performed by the Siamese model or triggering generation and routing of automated calls relating to particular product offerings on e-commerce sites based on a predicted successful outcome from the Siamese model. Siamese predictions have proven to provide at least a 30% increase in returns over prior methods used for customer acquisition data.

Traditional models to determine and predict efficacy of treatment effect modelling such as targeted digital marketing campaigns are not properly suited to the task, as their predictions are based on past instances of either success or failure of a treatment such as a marketing campaign—the traditional models cannot predict based on instances where the customer both did and did not receive the marketing campaign. Prior models are also prone to overfitting and unable to deal with unseen data. Typically, uplift models are developed for randomized experiments with both the treatment and outcome as binary random variables

Thus, in at least some aspects, an improved uplift modelling is desired, which performs incremental modelling or net modelling and provides predictive modelling that directly models the incremental impact of a treatment (e.g. a digital marketing action) on a user's behaviour.

In at least some aspects, there is provided, a computing system applying a new uplift loss function defined by leveraging a connection with the Bayesian interpretation of the relative risk, another treatment effect measure specific to the binary case. Defining an appropriate loss function for uplift also allows to use simple models for the related optimization problem, including complex models such as neural networks. When prediction becomes more important than estimation, neural networks become more attractive than classical statistical models. There are several reasons why neural networks are suitable tools for uplift: i) they are flexible models and easy to train with current GPU hardware; ii) with a single hidden layer modeling covariates interactions is straightforward; iii) they are guaranteed to approximate a large class of functions; iv) neural networks perform very well on predictive tasks which is the main objective of uplift; v) a simple network architecture ensures model interpretability for further studies.

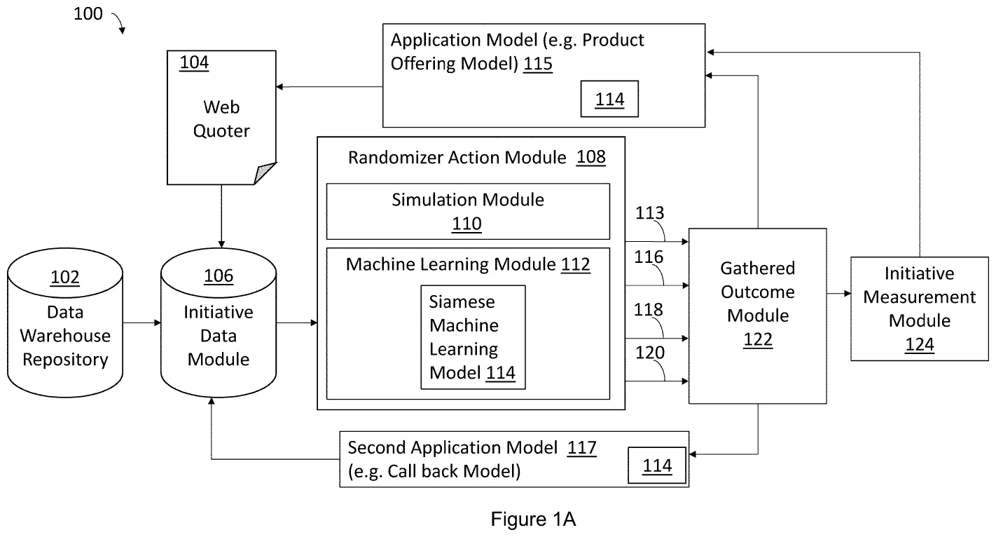

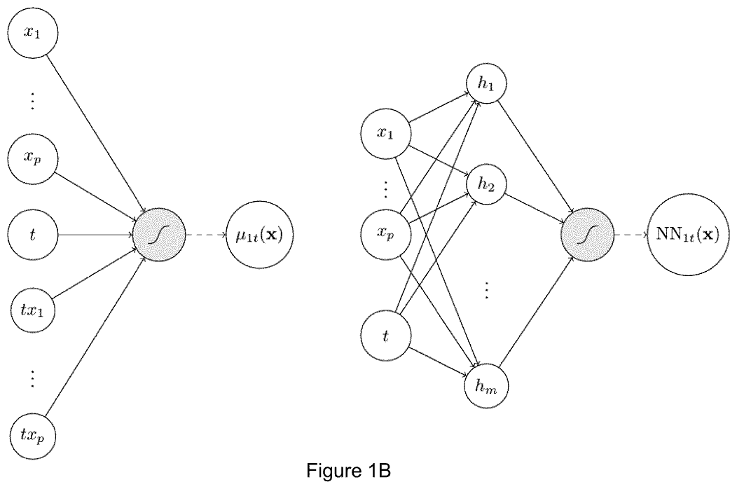

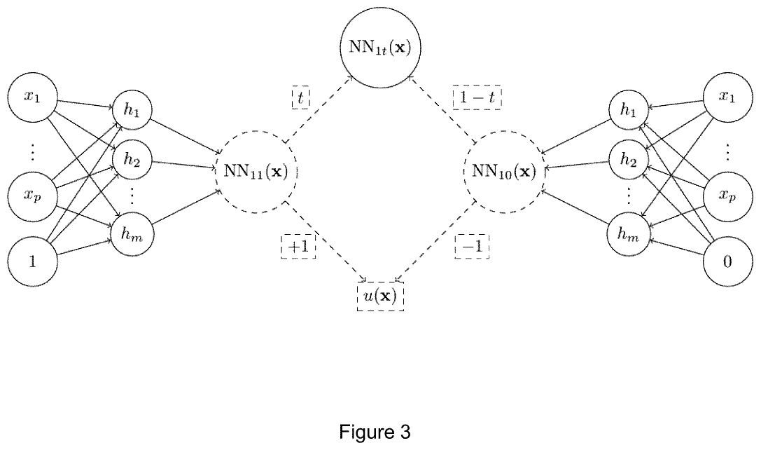

In at least some aspects, the proposed methods and systems are developed in the context of a specific neural network architecture (e.g. see FIG. 1A and FIG. 3) in which the proposed loss function can be easily optimized. The proposed solution uses a representation that improves the twin networks in the context of deep learning. This representation helps the fitting process to a great extent. In at least some aspects, the model generalizes uplift logistic interaction model to a 1-hidden layer neural network model. In the logistic regression context, one can use lasso to produce a sparse model. As more hidden nodes are added to the neural network, lasso becomes choosing the right number of parameters to include in the network (i.e., pruning). However, the fitting mechanism of statistically-driven methods such as the lasso needs to be adapted for stochastic gradient descent to provide a neural network pruning technique. Preferably, there is proposed a method of using a proximal version of gradient descent and to introduce a scaling factor for structured pruning. This allows to select automatically the number of neurons for each hidden layer. Compared to other existing methods, in at least some aspects, the proposed systems and methods offer a unified principled approach, in at least some aspects to obtain a sparse solution that provides well-optimized uplift estimates.

In at least some aspects, the proposed methods and systems allow: i) defining a new loss function for the neural network derived from an intuitive interpretation of treatment effects estimation; ii) generalizing the uplift logistic interaction model to a 1-hidden layer ReLU (Rectified Linear Unit) neural-network; iii) introducing a new twin neural architecture to predict conditional average treatment effects; iv) guiding model selection (or architecture search) with sparse group lasso regularization; v) establishing empirically the validity of the estimation procedure on both synthetic and real-world datasets.

As noted earlier, in practice, prior uplift modelling approaches are prone to overfitting and inaccuracies. In at least some aspects, there is provided a new computing architecture for uplift modeling. There is proposed a new loss function defined by leveraging a connection with the Bayesian interpretation of the relative risk. There is further proposed, in at least some aspects, a specific twin neural network architecture allowing jointly optimizing the marginal probabilities of success for treated and controlling individuals. This model is a generalization of the uplift logistic interaction model. The stochastic gradient descent algorithm may be modified to allow for structured sparse solutions. In at least some aspects, this helps training our uplift models largely. The proposed method and system are competitive in simulation setting and on real data from large-scale randomized experiments.

Additionally, as noted earlier, prior models were based on regression learning which were not task focused and thereby did not yield optimal results whereas the current model combines a particular unique architecture of artificial neural networks, which is fitted towards task-based predictions.

Generally, uplift modelling measures effectiveness of an action and may be applied herein to build a predictive model (e.g. twin neural model) that predicts incremental response to an action.

Generally, in at least some example embodiments, the Siamese neural model combined with a unique computing system architecture for testing and re-training the model as described herein, and only uses memory to store data learned parameters that are re-input into the original model for re-training thereby effecting size and probability of treatment while avoiding overfitting of the training data and improving uplift predictions.

### Techniques for Addressing Uplift

Uplift is a particular case of conditional treatment effect modeling which falls within the potential outcomes framework.

Let T be the binary treatment indicator, and X=(X₁, . . . , Xₚ) be the p-dimensional predictors vector. The binary variable T indicates if a unit is exposed to treatment (T=1) or control (T=0). Let Y(0) and Y(1) be the binary potential outcomes under control and treatment respectively. Assume a distribution (Y(0), Y(1), X, T)˜ [symbol] from which n iid samples are given as the training observations {(yᵢ, xᵢ, tᵢ)}ᵢ₌₁ⁿ, where xᵢ=(xᵢ₁, . . . , xᵢₚ) are realisations of the predictors and tᵢ the realisation of the treatment for observation i. Although each observation i is associated with two potential outcomes, only one of them can be realized as the observed outcome yᵢ. By Assumption 1, under the counterfactual consistency, each observation is missing only one potential outcome: the one that corresponds to the absent treatment either t=0 or t=1.

Assumption 1 (Consistency) Observed outcome Y is represented using the potential outcomes and treatment assignment indicator as follows:

Y=TY(1)+(1−T)Y(0).

In general, the following representation of [symbol] may be assumed herein:

X˜Λ

T˜Bernoulli(e(x))

Y(t)˜Bernoulli(m₁ₜ(x))

where Λ is the marginal distribution of X and e(⋅) is the propensity score (see Definition 1). The probabilities of positive responses for the potential outcomes under control and treatment are given by the functions m₁ₜ(⋅): [symbol] →(0,1) for t=0 and t=1 respectively.

Definition 1 (Propensity score) For any X=x, the propensity score is defined as:

e(x)=Pr(Tᵢ=1|Xᵢ=x). (1)

Given the notation above, the conditional average treatment effect (CATE) is defined as follows:

CATE(x)= [symbol] [Yᵢ(1)−Yᵢ(0)|Xᵢ=x] (2)

In order for the CATE to be identifiable, some additional assumptions may be made, standard in the world of causal inference. The propensity score parameter is widely used to estimate treatment effects from observational data. Assumption 2 states that each individual has non-zero probabilities of being exposed and being unexposed. This is necessary to make the mean quantities meaningful.

Assumption 2 (Overlap) For any X=x, the true propensity score is strictly between 0 and 1, i.e., for ϵ>0,

ϵ<e(x)<1−ϵ.

In at least some aspects, there is presented the case of randomized experiments, with e(x)=½, which is common in the uplift literature and is the case of our data.

Thus, the uplift is defined as the conditional average treatment effect in different sub-populations according to the possible values of the covariates, namely:

u(x)=Pr(Yᵢ=1|Xᵢ=x,T₁=1)−Pr(Yᵢ=1|Xᵢ=x,Tᵢ=0). (3)

To simplify the notation, we denote by m_{yt}(x) the corresponding conditional probability Pr(Yᵢ=y|Xᵢ=x, Tᵢ=t). Therefore, the uplift is the difference between the two conditional means m₁₁(x) and m₁₀(x). The traditional approach to model uplift is to build two independent models. This consists of fitting two separate conditional probability models: one model for the treated individuals, and another separate model for the untreated individuals. Then, uplift is the difference between these two conditional probability models. These models are called T-learners (T for “two models”) in the literature. The asset of T-learners is their simplicity, but they do not perform well in practice, because each model focuses on predicting only one class, so the information about the other treatment is never provided to the learning algorithm. In addition, differences between the covariates distributions in the two treatment groups can lead to bias in treatment effect estimation. There has been efforts in correcting such drawbacks through a combined classification model known as S-learner, for “single-model”. S-learner uses the treatment variable as a feature and to add explicit interaction terms between each covariate and the treatment indicator to fit a model, e.g., a logistic regression. The parameters of the interaction terms measure the additional effect of each covariate due to treatment.

Several proposed non-parametric methods take advantage of grouped observations in order to model the uplift directly. Some k-nearest neighbours based methods are adopted for uplift estimation. The main idea is to estimate the uplift for an observation based on its neighbourhood containing at least one treated and one control observations. However, these methods quickly become computationally expensive for large datasets. State-of-the-art proposed methods view random forests as an adaptive neighborhood metric, and estimate the treatment effect at the leaf node. Therefore, most active research in uplift modeling is in the direction of classification and regression trees where the majority are modified random forests. For example, modified split criteria that suited the uplift purpose were studied. The criteria used for choosing each split during the growth of the uplift trees is based on maximization of the difference in uplifts between the two child nodes. Within each leaf, uplift is estimated with the difference between the two conditional means. A good estimate of each mean may lead to a poor estimate of the difference. However, the existing tree-based uplift optimization problems do not take this common misconception into account. Instead, the focus is on maximizing the heterogeneity in treatment effects. Without careful regularization (e.g., honest estimation), splits are likely to be placed next to extreme values because outliers of any treatment can influence the choice of a split point. In addition, successive splits tend to group together similar extreme values, introducing more variance in the prediction of uplift. Alternatively some models use the transformed outcome, an unbiased estimator of the uplift. However, this estimate suffers from higher variance than the difference in conditional means estimator. In addition, for both estimators, if random noise is larger than the treatment effect, the model will more likely predict random noise instead of uplift. As a result, based on several experiments on real data, and although the literature suggests that tree-based methods are state-of-the-art for uplift, the published models overfit the training data and predicting uplift still lacks satisfactory solutions.

### An Uplift Loss Function

The following defines the uplift loss function that is used to fit the disclosed models herein, in at least some embodiments. One goal is to regularize the conditional means in order to obtain a better prediction of the quantity of interest, the uplift. In one aspect, there is proposed a composite loss function, which can be separated into two pieces:

[symbol]

(⋅)= [symbol] ₁(⋅)+ [symbol] ₂(⋅)

and to optimize both simultaneously. Since, generalizing the uplift logistic regression, the probability of positive response m₁ₜ(x) is modelled. Naturally, the first term can be defined as the negative log-likelihood or the binary cross entropy (BCE) loss, with y as the response, and m₁ₜ(x) as the prediction, that is,

$${ℓ}_{1} ( y , t \vert x ) = - \frac{1}{n} {\sum }_{i = 1}^{n} \{ {y}_{i} log {m}_{1 {t}_{i}} ( {x}_{i} ) \} + ( 1 - {y}_{i} ) log \{ 1 - {m}_{1 {t}_{i}} ( {x}_{i} ) \} ) .$$

The second term may be defined based on a Bayesian interpretation of another measure of treatment effect, the relative risk. First, the relative risk (or risk ratio) may be defined as as a function of the conditional means.

Definition 2 (Relative risk) For any X=x and m₁₀(x)>0, the relative risk is defined as follows:

$$RR ( x ) = \frac{Pr ( Y = 1 \vert X = x , T = 1 )}{Pr ( Y = 1 \vert X = x , T = 0 )} = \frac{{m}_{11} ( x )}{{m}_{10} ( x )} .$$

Relative risk is commonly used to present the results of randomized controlled trials. In the medical context, the uplift is known as the absolute risk (or risk difference). In practice, presentation of both absolute and relative measures is recommended. If the relative risk is presented without the absolute measure, in cases where the base rate of the outcome m₁₀(x) is low, large or small values of relative risk may not translate to significant effects, and the importance of the effects to the public health can be overestimated. Equivalently, in cases where the base rate of the outcome m₁₀(x) is high, values of the relative risk close to 1 may still result in a significant effect, and their effects can be underestimated. Interestingly, the relative risk can be reformulated as:

$$RR ( x ) = \frac{Pr ( T = 1 \vert Y = 1 , X = x )}{Pr ( T = 0 \vert Y = 1 , X = x )} ( \frac{1 - e ( x )}{e ( x )} ) ,$$

where the propensity score e(x) is given in Definition 1. For randomized experiments, the propensity score ratio {1−e(x)}/e(x) is a constant and, written in that form, the relative risk can be interpreted in Bayesian terms as the normalized posterior propensity score ratio (i.e., after observing the outcome). In the particular case where e(x)=½, it is easy to show that Pr(T=1|Y=1, X=x)=RR(x)/{1+RR(x)}. Moreover, there are the following equalities:

$$Pr ( T = 1 \vert Y = 1 , X = x ) = \frac{{m}_{11} ( x )}{{m}_{11} ( x ) + {m}_{10} ( x )} , \qquad ( 4 )$$

$$Pr ( T = 1 \vert Y = 0 , X = x ) = \frac{{m}_{01} ( x )}{{m}_{01} ( x ) + {m}_{00} ( x )} . \qquad ( 5 )$$

These two equalities give a lot of information. These may be referred to as posterior propensity scores and denoted by p_{yt}(x) the corresponding conditional probability Pr(T=t|Y=y, X=x). The posterior propensity scores are functions of the conditional means. The quantity p₁₁(x) can be seen as the proportion of treated observations among those that had positive outcomes and p₀₁ (x) can be seen as the proportion of treated observations among those that had negative outcomes. The second term of our uplift loss may be defined as the BCE loss, but this time, using the observed treatment indicator t as the “response” variable, and p_{y1}(x) as the “prediction”. Formally, it is given by:

$${ℓ}_{2} ( t , y \vert x ) = - \frac{1}{n} {\sum }_{i = 1}^{n} \{ {t}_{i} log \{ {p}_{{y}_{i} 1} ( {x}_{i} ) \} + ( 1 - {t}_{i} ) log \{ 1 - {p}_{{y}_{i} 1} ( {x}_{i} ) \} ) .$$

Taken alone, the second loss models the posterior propensity scores as a function of the conditional means (for positive and negative outcomes). Intuitively, if a treatment has a significant positive (resp. negative) effect on a sub-sample of observations, then within the sample of observations that had a positive (resp. negative) response, can expect a higher proportion of treated. Formally, the complete uplift loss function is defined in Definition 3.

Definition 3 Let m_{yt} [symbol] m_{yt}(x)=Pr(Y=y|X=x, T=t), and p_{yt} [symbol] p_{yt}(x)=m_{yt}/(m_{y1}+m_{y0}). The uplift loss function is then defined as follows:

$$ℓ ( y , t \vert x ) = - \frac{1}{n} {\sum }_{i = 1}^{n} \{ {y}_{i} log {m}_{1 {t}_{i}} + ( 1 - {y}_{i} ) log {m}_{0 {t}_{i}} + {t}_{i} log {p}_{{y}_{i} 1} + ( 1 - {t}_{i} ) log {p}_{{y}_{i} 0} \} . \qquad ( 6 )$$

Although the case is considered where e(x)=½, the development holds for any constant e(x). An under-sampling or an over-sampling procedure allows to recover the e(x)=½ if the constant is below or above ½ respectively. Interestingly, it is possible to find a connection between the uplift loss function and the likelihood of the data. Indeed, the described relation between the relative risk and the conditional probabilities m₁₁(x) and m₁₀(x), as well as the Bayesian interpretation of the posterior propensity scores p_{yt}(x) suggest modeling the joint distribution of Y and T. Formally, the connection can be shown through the following development.

$$\begin{matrix}Pr ( Y = y , T = t \vert X = x ) = Pr ( T = t \vert Y = y , X = x ) Pr ( Y = y \vert X = x ) \\ = {p}_{yt} ( x ) \{ {m}_{y 1} ( x ) e ( x ) + {m}_{y 0} ( x ) [ 1 - e ( x ) ] \} \\ = {p}_{yt} ( x ) \{ {m}_{y 1} ( x ) + {m}_{y 0} ( x ) \} / 2 ,\end{matrix}$$

because e(x)=½. Therefore, the likelihood for n observations is proportional to

Πi=1p_{y}_{ᵢ}₁^{t}^{ᵢ}p_{y}_{ᵢ}₀^{(1-t}^{ᵢ}⁾{m₁₁+m₁₀}^{y}^{ᵢ}{m₀₁+m₀₀}^{(1-y}^{ᵢ}⁾,

and the log-likelihood is proportional to

Σᵢ₌₁ⁿ{yᵢ log(m₁₁+m₁₀)+(1−yᵢ)log(m₀₁+m₀₀)+tᵢ log p_{y}_{ᵢ}₁+(1−tᵢ)log p_{y}_{ᵢ}₀}. (7)

Notice that the functions (6) and (7) differ only in that (6) uses m₁ₜ while (7) specifically uses m_{y1} and m_{y0}, the conditional means under treatment and control. Traditionally, m₁ₜ is more common since in practice, each observation can only be treated or not treated. However, the results were compared by fitting uplift models using both functions. The results being very similar, in the rest of the disclosure, the results may be presented for models fitted with the augmented loss function (6). The loss function (6) can also be interpreted term by term. The first term is simply the binary cross entropy loss with respect to the conditional means. The second term can be seen as a regularization term on the conditional means. In the second term, the conditional means are represented through the posterior propensity scores. By minimizing the augmented loss, the first term focuses on estimating the conditional means separately while the second term tries to correct for the posterior propensity scores. Since both terms are minimized simultaneously, this can also be seen as a special case of multi-task learning. As will be described, in at least some aspects, this new parameter estimation method greatly improves the predictive performance of the underlying uplift models.

### A Twin Neural Model for Uplift

The uplift interaction model can be represented by a fully-connected neural network with no hidden layer, an intercept, 2p+1 input neurons (covariates, treatment variable and interaction terms) and 1 output neuron with sigmoid activation function, where σ(z)=1/(1+e^{-z}), for z ∈ [symbol] (see FIG. 1B left panel). Let x=(x₁, . . . , xₚ) ∈ [symbol] be the covariates vector and t ∈ {0,1}, a binary variable. Let us further define θⱼ, for j=1, . . . , 2p+1, the coefficient or weight that connects the jth input neuron to the output and let θₒ Σ [symbol] be the intercept. The uplift interaction model can be written as:

μ₁ₜ(x,θ)=σ(θₒ+Σⱼ₌₁^{p}θⱼxⱼ+Σⱼ₌ₚ₊₁^{2p}θⱼtxⱼ₋ₚ+θ₂ₚ₊₁t), t∈{0,1}, (8)

where σ(⋅) represents the sigmoid function and θ denotes the vector of model parameters. The predicted uplift associated with the covariates vector xₙ₊₁ of a future individual is

û(xₙ₊₁)=μ₁₁(xₙ₊₁,\hat{θ})−μ₁₀(xₙ₊₁,\hat{θ}),

where \hat{θ} may be estimated by minimizing a loss function such as the one defined in Equation (6).

Referring to FIG. 1B shown is a graphical representation of the uplift interaction model (left panel) and neural network representation of the uplift model (right panel of FIG. 1B). Note that hₖ=ReLU(x, t) for k=1, . . . , m. For m=2p+1, Theorem 1 shows the equivalence between the interaction model (8) and a particular case of the 1-hidden layer neural network (9) with ReLU activation. In both diagrams, the gray node represents the sigmoid activation function.

More generally, let NN₁ₜ(x, θ) for t ∈ {0,1} be a neural network. We denote by NN₁₁(x, θ) and NN₁₀(x, θ) the conditional mean model for treated and control observations respectively. In at least some aspects, one goal is to generalize the interaction model (8) by a more flexible neural network. Thus, focus is on a fully-connected network with an input of size p+1 (covariates and treatment variable), and one hidden layer of size m>1 with ReLU activation, where ReLU(z)=max{0, z}, for z ∈ [symbol] . It is assumed that the intercept (also called bias term) is inherent in the neural model. The hidden layer is then connected to a single output neuron with a sigmoid activation (see FIG. 1B right panel). The output of the neural network NN₁ₜ(x, θ) can be written as:

NN₁ₜ(x,θ)=σ{θₒ⁽²⁾+Σₖ₌₁^{m}θₖ⁽²⁾ReLU(θ_{o,k}⁽¹⁾+Σⱼ₌₁^{p}θ_{j,k}⁽¹⁾xⱼ+θ_{p+1,k}⁽¹⁾t)}, t∈{0,1}, (9)

where θ_{j,k}⁽¹⁾ represent the coefficient or weight that connects the jth covariate or input neuron to the kth hidden neuron and θₖ⁽²⁾ represents the coefficient that connects the kth hidden neuron to the output. We denote the bias terms for the hidden layer and the output layer by θ_{o,k}⁽¹⁾, k=1, . . . , m and θ₀⁽²⁾ respectively. Here, θ contains all of the neural network's coefficients (or parameters). The predicted uplift associated with the covariates vector xₙ₊₁ of a future individual is:

û(xₙ₊₁)=NN₁₁(xₙ₊₁,\hat{θ})−NN₁₀(xₙ₊₁,\hat{θ}),

where \hat{θ} may be estimated by minimizing a loss function such as the one defined in Equation (6). In the following Theorem, we show that for a judicious choice of the neural network's coefficients matrix, the two models are equivalent.

Theorem 1 Let μ₁ₜ(x) and NN₁ₜ(x) be two uplift models defined as in (8) and (9) respectively. Let c ∈ [symbol] be a positive and finite constant and m=2p+1. For all θⱼ ∈ [symbol] , j=1, . . . , 2p+1 and θₒ ∈ [symbol] , there exists a matrix of coefficients (θ_{j,k}⁽¹⁾) ∈ [symbol] , such as

$$( {θ}_{j , k}^{( 1 )} ) = ( \begin{matrix}1 & 0 & … & 0 & 1 & 0 & … & 0 & 0 \\ 0 & 1 & … & 0 & 0 & 1 & … & 0 & 0 \\ ⋮ & ⋮ & ⋱ & ⋮ & ⋮ & ⋮ & ⋱ & ⋮ & ⋮ \\ 0 & 0 & … & 1 & 0 & 0 & … & 1 & 0 \\ 0 & 0 & … & 0 & c & c & … & c & 1\end{matrix} ) ,$$

an intercepts vector (θ_{o,k}⁽¹⁾) ∈ [symbol] , a vector of coefficients (θₖ⁽²⁾) ∈ [symbol] and an intercept scalar θₒ⁽²⁾ ∈ [symbol] such that for all x ∈ [0, c]^{p} and t ∈ {0,1}

μ₁ₜ(x)=NN₁ₜ(x). (10)

The above theorem is interesting as it illustrates the neural network model as proposed herein in at least some embodiments, is much more flexible and can be seen as a generalization of the interaction model. As will be described, in at least some aspects, this flexibility allows a better fit resulting in a higher performance from a prediction point of view.

### A Twin Representation of Uplift Models

For most existing parametric uplift methods, the uplift prediction is computed in several steps: i) the uplift model is fitted; ii) the conditional probabilities are predicted by fixing the treatment variable T to 1 or 0; iii) the difference is taken to compute the uplift; iv) the uplift is visualized. The fitted model plays a major role in implementing each of these steps. This can be problematic when the fitted model overfit the data at hand. Therefore, most multi-steps methods require careful regularization. To simplify this task, in at least some implementations, there is proposed a method and architecture to combine the whole process into a single step through a twin model.

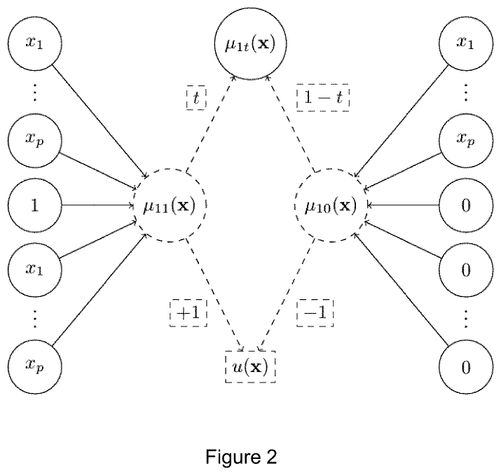

The twin interaction model diagram is visualized in FIG. 2 which provides a diagram of the twin logistic interaction model. The original interaction model is separated into two sub-components with the same parameters. For the left sub-component, the treatment variable fixed to 1 and the interaction terms to x. The treatment variable and the interactions terms are fixed to 0 for the right sub-component. The sub-components model the conditional means for treated (μ₁₁(x)) and for control (μ₁₀(x)). The difference gives direct prediction of u(x). At the same time, the predicted conditional mean μ₁ₜ(x) is based on the actual received treatment for each individual t ∈ {0,1}, i.e., μ₁ₜ(x)=tμ₁₁(x)+(1−t)μ₁₀(x).

A twin neural network, as disclosed herein, consists of two models that use the same parameters (or weights) while fitted in parallel on two different input vectors to compute comparable outputs. In at least some embodiments of the disclosure, in the disclosed twin or Siamese neural network model (e.g. see FIG. 3), the input vectors are almost identical, only the treatment variable is changed. The parameters between the twin networks are shared. Weight sharing guarantees that two individuals or targets with similar characteristics are mapped similarly by their respective networks because each network computes the same function.

The twin network representation of the uplift interaction model is subsequently generalized to neural networks, as show in FIG. 3, in at least one embodiment. In at least one implementation of the twin network, each observation is duplicated and the treatment variable is fixed to 1 and 0, while keeping in memory the true value t of the treatment variable. This makes it possible to fit the twins in parallel and to use the true value t to compute NN₁ₜ(x). The availability of NN₁₁(x) and NN₁₀(x) allows to compute the uplift loss function (6) and to predict the uplift u(x) in a single step, which simplifies the fitting process to a great extent.

Referring to FIG. 3, shown is a twin neural model for uplift (also referred to as a Siamese neural network herein), in accordance with one or more embodiments of the disclosure.

The inputs contain the covariates vector x and, for the left sub-component of FIG. 3, the treatment variable fixed to 1. The treatment variable is fixed to 0 for the right sub-component. The sub-components output the predicted conditional means for treated NN₁₁(x) and for control NN₁₀(x). The difference gives direct prediction of u(x). At the same time, the predicted conditional mean NN₁ₜ(x) is based on the actual received treatment for each individual t ∈ {0,1}, i.e., NN₁ₜ(x)=tNN₁₁(x)+(1−t)NN₁₀(x).

Referring now to FIG. 1A, there is shown a schematic block diagram of a computing system architecture 100 and example method for applying and assessing the efficacy of a Siamese neural network (also referred to as a twin neural network model for uplift) including the efficacy of a proposed treatment and optimizing the Siamese neural network in accordance with one or more aspects of the present disclosure. In one aspect, optimizing the Siamese neural network includes providing and applying a randomizer device for random selection and applications of the model or a a random model and result and utilizing a result of the randomizer device for performing re-training of the Siamese model to improve efficacy at a subequent application of the Siamese neural model.

The system 100 comprises a data warehouse repository 102, an initiative data module 106, a web quoter 104, a randomizer action module 108 (also referred to as a randomizer or action master herein), a gathered outcome module 122, an initiative measurement module 124, a first application model 115 (e.g. a product offering model generating one or more predicted product offering suggestions generated by a Siamese machine learning model 114 for a web quoter 104), a second application model 117 (e.g. a call back model triggering an automated generation of calls from one or more associated computing devices in response to one or more predicted offerings and treatments generated by the Siamese model 114), and a web quoter 104. Each application model 115 and 117 further comprises an instance of the siamese machine learning model 114, in at least some aspects. Although two application models have been illustrated for simplicity, additional application models may be envisaged. For example, a different application model and corresponding SMITE, or Siamese machine learning model 114 may be provided for each different e-commerce product offering to provide predictions as described herein.

The randomizer action module 108 further comprises a simulation module 110, a machine learning module 112 and a Siamese machine learning model 114 (also referred to as twin neural model for uplift herein). Each application model 115, 117 (or other additional application models not shown for simplicity) implement the Siamese machine learning model 114 to determine a decision as to whether to perform a specific computing action, such as generating an online product offering related to a product of interest on one or more websites or computing applications such as the web quoter 104 or triggering the generating of an automated call from one or more computing devices (not shown in FIG. 1A for simplicity) for providing a call back relating to a particular product of interest based on a prediction provided by the Siamese model 114 that such an action, e.g. automated call back would be successful.

Data Warehouse Repository 102 is an information bank or storage bank, containing previous information about a source and interactions with a destination, e.g. metadata relating to an e-commerce client associated with a computing device for an online merchant of an entity inquiring for product offerings offered by an e-commerce merchant. In some embodiments, the data within the data repository is in the form of a client list of existing clients and contains information about the targets such as their insurance information, including age, car type, where they live, how they behave, gender, etc as well interactive actions taken by users or clients in the networked system architecture 100 including, while browsing online and interacting with the web quoter 104 offering e-commerce products, such as but not limited to: amount of time spent on the web quoter 104, as well as device information for clients interacting in the system 100, browser cookie information including type of device, origin source, online interactions leading to the web quoter 104, etc.

In some aspects, the data warehouse repository 102 further comprises data in relation to one or more targets of a proposed treatment, this information bank containing the results of a prior trial whereby some of the targets who are included in the information bank have already received the proposed treatment, and their response to said treatment is included in the information bank of the data warehouse repository 102.

The web quoter 104, may be a website or a native application or dedicated computing device which collects information from clients interacting with the web quoter 104 and based on inputs, including inputs from an application model 115 applying a Siamese-based prediction model, such as the Siamese machine learning model 114 to predict a potential success of a targeted e-commerce marketing offering on an individual customer interacting with the web quoter 104, based on data derived from simulations on different scenarios where both the customer was targeted and the customer was not targeted. The web quoter 104, may thus utilize such inputs of information from the application model 115 and perform a determine of type of information which will be presented on a user interface associated with the web quoter 104 comprises data encapsulating information derived from target interactions on a web-based quoter, such as in the form of a web-based questionnaire designed to provide quotes to targets. The data contained in the web quoter 104 may be stored directly thereon (e.g. on the software application providing the web quoter 104) or on an associated repository or memory and includes interactions performed on the web-based quoter, browsing information, browser cookie information, etc.

Referring again to FIG. 1A, an initiative data module 106 is configured to create a set of input data comprising target data to the randomizer action module 108 by merging or otherwise combining data from different data sources, such both the data warehouse repository 102 and the web quoter 104, and/or feedback or output from other application models within the system 100 such as the second application model 117 applying the Siamese machine learning model 114 for performing predictions relating to a call back model as described herein.

Randomizer action module 108 comprises a simulation module 110 and a machine learning module 112 further comprising an artificial neural network, such as a Siamese machine learning model 114. An example schematic of the implementation of the Siamese machine learning model 114 which comprises a twin neural model for uplift as an artificial neural network (providing a prediction of u(x) along with a prediction of a conditional mean NN₁ₜ(x) is based on the actual received treatment for each individual t ∈ {0,1}, i.e., NN₁ₜ(x)=tNN₁₁(x)+(1−t)NN₁₀(x), is shown in the example of FIG. 3. The randomizer action module 108 is configured to receive the set of input data from the initiative data module 106. Once received by the randomizer action module 108, a simulation module 110 randomly determines which target data from the set of input data extracted from the initiative data module 106 will be run through the machine learning module 112 (e.g. the Siamese machine learning model 114) and which other target data from the set of input data will have its potential outcomes randomly generated. Furthermore, the simulation module 110 may further determine for the other target data which has its outcome randomly generated, on a randomized basis, which output yields a positive action or treatment and which yields a negative action or treatment (e.g. in the application of the call back model, such positive action may be triggering an automated call back or a negative action may be, not triggering any call backs). Such random triggering defined by the simulation module 110 may be based a predefined threshold assigning a random number of target inputs to have a Siamese machine learning model 114 applied thereon and other defined number having a randomly generated output of prediction. The selection of which targets are assigned to a random model or a Siamese model 114 may be randomly performed by the randomizer action module 108.

In one example implementation, the simulation module 110 will make a random decision in a given timeframe on whether the Siamese model 114 is applied to the input data or not to generate a desired prediction (e.g. route a call or not to the top 10 target individuals via associated computing device). In the example call back model application (e.g. second application model 117), a positive treatment prediction may cause generating a call and a non-treatment prediction may cause no call. Thus, the simulation module 110 will make an initial random decision on whether the Siamese model should be applied to the input data or a random output generated, and then if a random output is selected, a further random selection is made by the simulation module 110 as to whether the random output prediction indicates a treatment or not.

Generally, in at least some aspects, the randomizer action module 108 may be configured to take as an input, the model estimations (e.g. as generated via the application model 115 and/or the second application model 117 containing the Siamese machine learning model 114 for different application or product types, etc.) and provide a decision as to what action should be taken (e.g. whether an automated call is made or not) from the initiative standpoint. The randomizer action module 108 may also be configured to compare an actual outcome of whether a treatment was performed or not versus a predicted outcome for treatment, and may combine the value obtained from the model and score the model onto the dataset, this may be stored in the gathered outcome module 122.

If the potential outcomes of the input target data is randomly generated, the randomizer action module 108 randomly selects one of two binary output, e.g. whether to provide treatment to the intended target, e.g. random treatment output 113, or whether to not provide the potential treatment to the intended target, e.g. generating a random non-treatment output 116. For example, a positive treatment output may be to generate an action for a specific application or factor, such as a digital marketing intervention which may include an automated call or an e-commerce product offering via a targeted advertising on the web quoter 104 while a non-treatment output may be to not perform the particular intervention.

If the potential outcomes from the set of input data is to be determined by the Siamese machine learning model 114 as assigned by the simulation module 110 then this may include running a simultaneous twin neural network simulation whereby the target data from the set of input data is identically fed into a set of two parallel tracks with the exception of one variable added to one track and not the other, this simulation also including a third track that represents the truth, or whether the target had received the treatment in the trial and how they responded to the treatment. Thus, the outputs generated by affecting the model input data onto the Siamese machine learning model 114 may include binary outputs of a model treatment output 118 (e.g. perform the intervention) or a model non-treatment output 120 (e.g. indicative of a prediction to not perform the intervention or treatment).

An implementation of such a twin neural model for uplift utilized by the Siamese machine learning model 114 is described in relation to FIG. 3, whereby each observation is duplicated and the treatment variable may be fixed to 1 and 0, while keeping in memory of the machine learning module 112, the true value of the treatment variable such that the twins are fitted in parallel and the true value is used to compute the predicted conditional mean. Put another way, in one implementation of the Siamese machine learning model 114, the neural network may consist of two models that apply the input vectors in parallel which are almost identical, with only the treatment variable being changed and the parameters between the twin networks being shared, to compute comparable outputs.

Machine learning module 112 may be configured to receive the output data from the set of two parallel tracks as well as the data from a third track (representing the “truth”) as generated by the Siamese machine learning model 114 and predict, using the Siamese machine learning model 114, an uplift assessment based on uplift modelling of a difference in output between the output data from the set of two parallel tracks of the model, an example of the two parallel tracks illustrated graphically in FIG. 3.

In at least some aspects, one technique and implementation of the system 100 is to allow for optimizing a pseudo likelihood of the client response to an incentive providing that the “true” likelihood is not observable. This is achieved by the described architecture.

Instead of optimizing the regular x-entropy loss in a bi-model prediction framework the following uplift loss function is defined as described earlier:

$$ℓ ( y , t \vert x ) = - \frac{1}{n} {\sum }_{i = 1}^{n} \{ {y}_{i} log {m}_{1 {t}_{i}} + ( 1 - {y}_{i} ) log {m}_{0 {t}_{i}} + {t}_{i} log {p}_{{y}_{i} 1} + ( 1 - {t}_{i} ) log {p}_{{y}_{i} 0} \} .$$

The proposed architecture (Siamese neural network described herein and shown as Siamese machine learning model 114) is then used to optimize efficiently this uplift loss function:

$${NN}_{1 t} ( x , θ ) = σ \{ {θ}_{o}^{( 2 )} + {\sum }_{k = 1}^{m} {θ}_{k}^{( 2 )} ReLU ( {θ}_{o , k}^{( 1 )} + {\sum }_{j = 1}^{p} {θ}_{j , k}^{( 1 )} {x}_{j} + {θ}_{p + 1 , k}^{( 1 )} t ) \} , t ∈ \{ 0 , 1 \} ,$$

where NN₁ₜ(x, θ) for t Σ {0,1} is the output of a neural network as shown in FIG. 3 and earlier described in relation to equation 9.

Applying the architecture of FIG. 3 for the Siamese machine learning model 114 as configured to optimize the loss function noted above and in the system architecture of FIG. 1A, allows for training of tabular input usually available from the different prospects that are aimed to target and provide a priority for such prospects or targets from the input data, e.g. initiative data module 106.

Machine learning module 112 further generates in real-time, in response to the uplift assessment, a determination of whether a particular proposed treatment would have an expected effect on the target of the proposed treatment.

Based on performance results from the randomizer action module 108 including whether the proposed treatment would have an expected effect, in some aspects, each application model 115 and 117 may further determine whether to perform or trigger the proposed treatment on an intended target or whether to not perform the proposed treatment to the intended target or otherwise retrain the siamese machine learning model 114.

Gathered outcome module 122 may be configured to receive data corresponding to the output from the Siamese machine learning model 114 and/or the randomizer action module 108 corresponding a prediction as to whether to perform the proposed treatment on the intended target, or not as well as data corresponding to the output from the randomly selected outcomes from the randomizer action module 108 further determining whether to provide treatment to the intended target of the treatment, or whether to not provide the potential treatment to the intended target of the treatment.

The gathered outcome module 122 may further be configured to compile data based on whether the Siamese model 114 was applied to the input data or a random output generated from the input data to the randomizer action module and additional data relating to an actual outcome from the intended target of the model for the treatment or lack of treatment generated. The gathered outcome module 122 may, in at least some aspects, compile data pertaining to the intended targets' response (e.g. subsequent action and engagement in response to a call or a product offering presented on a website) to either receiving the proposed treatment or not receiving the proposed treatment. Examples of types of responses, which may be captured from targets via user interfaces on associated computing devices for receiving and/or displaying the proposed treatment or lack of treatment on an an interactive user interface may include the intended target, in response to the proposed treatment or lack of treatment: completing purchases or sales via associated computing devices having been triggered to display the treatment (e.g. on an e-commerce website such via offering on a web quoter 104), target indicating their interest via their associated computing device and user interface (e.g. target browsing to a website related to the product offering associated with the treatment), target indicating they are not interested (e.g. target browsing away from a website related to the product offering associated with the treatment), etc.

Although example treatments predicted by the machine learning module 112 and the application models 115 and 117 may have been described herein as targeted digital marketing interventions for e-commerce product offerings, generation and routing of automated calls as an intervention, the Siamese machine learning model 114 may be used to predict other types treatments or potential interventions, in other aspects.

As illustrated in FIG. 1A, there are provided two different application models, application models 115 and 117, assessing the effect of different potential interventions based on the data processed by the underlying Siamese machine learning model 114 implemented therein. For example, the application model 115 may be a product offering model which determines target behaviours caused by the specific treatment of offering certain products on a website such as the web quoter 104, including subsequent interactions by the target with the web quoter 104 or in performing subsequent online transactions relating to the product offered on the web quoter 104. The application model 115 may determine the types of products to be offered on an e-commerce website based on predicted behaviours of conditional treatment effect modelling from the Siamese model. In the example illustrated, the second application model 117 relates to a call back model which may provide an estimation or prediction on the effect of a potential intervention, namely, generation of a call to a target device relating to a particular e-commerce product. As further illustrated in FIG. 1A, both the application model 115 and the second application model 117 each comprising a particularly configured Siamese machine learning model 114 are re-trained from the outcome gathered via the gathered outcome module 122. As shown in FIG. 1A, such updated Siamese machine learning model 114 having been retrained, along with other relevant data from the web quoter 104, may be fed back via the initiative data module 106 to update the Siamese machine learning model 114 utilized by the randomizer action module 108 at a subsequent iteration.

Put another way, in at least some aspects, the gathered outcome provided in the gathered outcome module 122 is provided as a target variable (e.g. the variable whose values are modeled and predicted by other variables in the model) to re-train the Siamese machine learning model 114 held within each of the application models 115 and 117, as needed to account for the additional feedback information.

Conveniently, in this way, the randomizer action module 108 operating as noted herein to randomly select whether to apply the Siamese neural model 114 to the input data or generate a random binary output and providing results of same along with a determination of whether the predicted output of the randomizer action module 108 (e.g. outputs 113, 116, 118 and 120) aligned with the truth or reality actually experienced to the relevant application models for retraining of the model, assists with generalization of the model and reduces overfitting. It also assists with determining whether a predicted estimate of an effect of a proposed treatment as stored in the model 114 is accurate or may need to be adjusted. In this way, predictions generated by the application models 115 and 117 (and specifically the Siamese machine learning models contained therein) may be adjusted as needed, in an iterative manner, on subsequent iterations of the model based on results from the randomizer, e.g. the randomizer action module 108 and the gathered outcome module 122. Conveniently, through this comparison of randomly generated outcomes to Siamese neural model-generated outcomes, the system 100 can re-train the Siamese models 114 to address issues in potential population bias distorting its future model outcomes.

Conveniently, in at least some aspects, by continually and iteratively re-training the Siamese machine learning models 114 and providing feedback to the machine learning module 112, the efficiency and accuracy of the system is improved, thereby improving the efficiency of the computing device, e.g. the computing device 200 implementing the operations and computing system architecture of FIG. 1A.

As mentioned earlier, in some implementations, initiative measurement module 124 is configured to receive the compiled data from the gathered outcome module 122 and compare the intended targets' responses who received the potential treatment based output from the Siamese-based machine learning model 114 against the intended targets' responses who received the potential treatment based upon the randomly selected outcomes of the randomizer action module 108. Such a comparison of the model 114 performance to the random output performance provided in some aspects to generate a randomized output by the randomizer action module 108, providing a comparison of the model to a random output generator are computed by the initiative measurement module 124 and further fed back to re-train the Siamese machine learning models 114.

In some aspects, the initiative measurement module 124 may further determine a performance comparison between prediction outputs generated by the randomizer and prediction outputs generated by applying the model to the dataset to perform a comparison of each of their performances (e.g. versus actual outcomes such as whether the prediction actually occurred or not) as compared to one another to determine which of the random prediction or model prediction outperforms and feeding such result further for retraining the model in a subsequent iteration.

Thus, initiative measurement module 124 subsequent to generating a comparison between the model and a random output generator within the randomizer action module 108 provides that comparison data back to the Siamese machine learning model 114 implementations (e.g. in application models 115 and 117) in order to continue to train iteratively those twin neural models and refine the Siamese machine learning model 114 and the machine learning module 112.

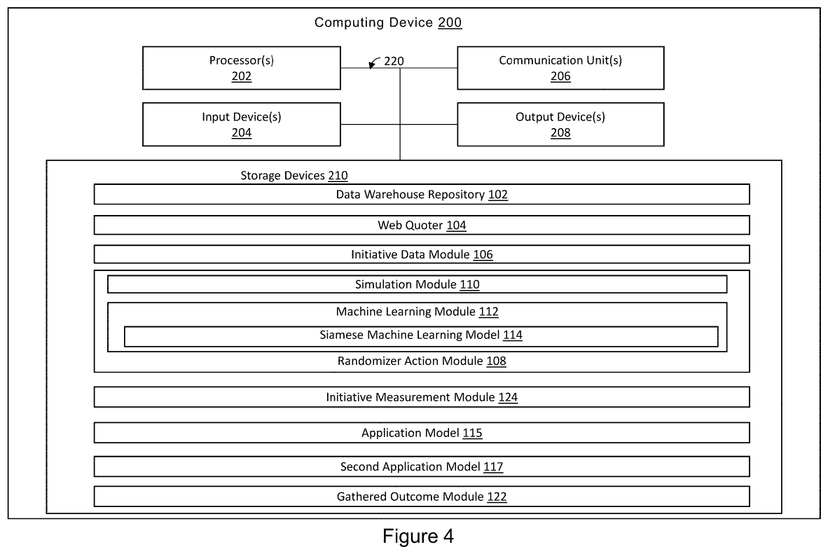

Referring now to FIG. 4, shown is a block diagram of an example computing device, 200 that can be used to perform a method and implement the computing modules, as discussed with reference to FIG. 1A, in accordance with one or more aspects of the present disclosure.

Computing device 200 comprises one or more processors 202, one or more input devices 204, one or more communication units 206 and one or more output devices 208. Computing device 200 also includes one or more storage devices 210 storing one or more modules comprising: data warehouse repository 102, web quoter 104, initiative data module 106, simulation module 110, machine learning module 112, Siamese machine learning model 114, randomizer action module 108, gathered outcome module 122, initiative measurement module 124, application model 115, and second application model 117. Communication channels 220 may couple each of the components including processor(s) 202, input device(s) 204, communication unit(s) 206, output device(s) 208, storage device(s) 210 and the various modules and repositories contained therein for inter-component communications, whether communicatively, physically and/or operatively. In some examples, communication channels 220 may include a system bus, a network connection, an inter-process communication data structure, or any other method for communicating data.

Additional modules and devices that may be included in various embodiments may not be shown in FIG. 4 to avoid undue complexity of the description. For example, an operating system, additional user interfaces, the network and interfaces through which the device 200 communicates with other devices is not shown in FIG. 4.

One or more processors 202 may implement functionality and/or execute instructions within computing device 200. For example, processors 202 may be configured to receive instructions and/or data from storage devices 210 to execute the functionality of the modules shown in FIG. 4, among others (e.g. operating system, applications, etc.). Computing device 200 may store data/information to storage devices 210. Some of the functionality is described further herein below.

One or more communication units 206 may communicate with external devices via one or more networks (e.g. communication network, not shown) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 220).

The one or more storage devices 210 may store instructions and/or data for processing during operation of computing device 200. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

The modules within the storage device 210 such as when executed by the one or more processors 202 provide the functionality to acquire one or more datasets including images and/or text related to a prediction task and utilize a randomizer action module to assign a random selection of whether to apply an artificial neural network comprising a Siamese neural network configured for uplift (e.g. as shown in FIG. 3) to the dataset or whether to perform a random prediction for the prediction task. The instructions within the modules may further configure the computing device 200 that subsequent to the random selection, a gathered outcome is collected for each prediction scenario based on applying or not applying the model (or the randomized output generator) to the dataset including a difference between the gathered outcome for each scenario (e.g. as compared between the Siamese model output and the random output generated as well as a comparison between expected and actual outcomes for the model) and fed back as the learned parameters such as the gathered outcome and the difference to retrain the Siamese neural network model (e.g. Siamese machine learning model 114) for use in performing the prediction task. As noted earlier, the prediction task may be related to determining the cause and effect inference for a specific factor, such as a treatment. Computing device 200 may communicate retrained models for processing of predictions for various applications, in subsequent iterations of the model.

It is understood that operations may not fall exactly within the modules and storages of FIG. 4 such that one module may assist with the functionality of another.

### Examples of Siamese Machine Learning Model 114

In accordance with some example embodiments and with reference to FIGS. 1A, 3, 4-6, the Siamese-based prediction model (e.g. Siamese machine learning model 114) is able to predict the success of a targeted intervention such as marketing campaign on an individual customer based on data derived from simulations on different scenarios where both the customer was targeted and the customer was not targeted. In doing this, the Siamese-based machine learning model 114 can also analyze and explain the difference between the two predictions. Prior methodologies are simply focused on having only one of: a good prediction or a heterogeneous prediction, but those two factors do not always go hand in hand. The SMITE model disclosed herein, also referred to as the Siamese machine learning model 114 allows for both factors to provide an accurate prediction.

In accordance with some embodiments, the Siamese machine learning model 114 functions generally by predicting whether a particular treatment, e.g. a digital marketing intervention presenting a digital offering of one or more e-commerce products on websites or native applications will influence a target to respond positively to the treatment. In at least some aspects, in making this prediction, the Siamese machine learning model 114 (or SMITE model) divides potential input targets into four categories in terms of receptiveness to a potential treatment or intervention: 1) persuadable, 2) sure thing, 3) lost cause, and 4) do-not-disturb. The Siamese machine learning model 114 (e.g. SMITE), may function, in at least some aspects by using a twin neural model for predicting which category the target falls into, with the aim of isolating the target data that fall into a desired category for performing an action in response for a treatment.

In at least some aspects, one advantage of the Siamese machine learning architecture 114 is that the Siamese neural network model can create a prediction of how an input target may respond based on modeling of what would occur if the target user were targeted for a treatment versus if they were not targeted for the treatment.

In at least some aspects and as described herein with reference to FIGS. 1A and 3, the Siamese model 114 functions by forcing two parallel neural networks to be the same in terms of input and structure, but by tweaking a variable in one network (e.g. treatment variable changed) and not the other such that the difference in final output can be attributed to that variable. In this case, the tweaked variable may be whether the target or source user received the particular treatment. The difference in the outputs between the two neural network structures (e.g. see FIG. 3) is used to inform whether targeting the treatment effort towards that input target user will be effective or not.

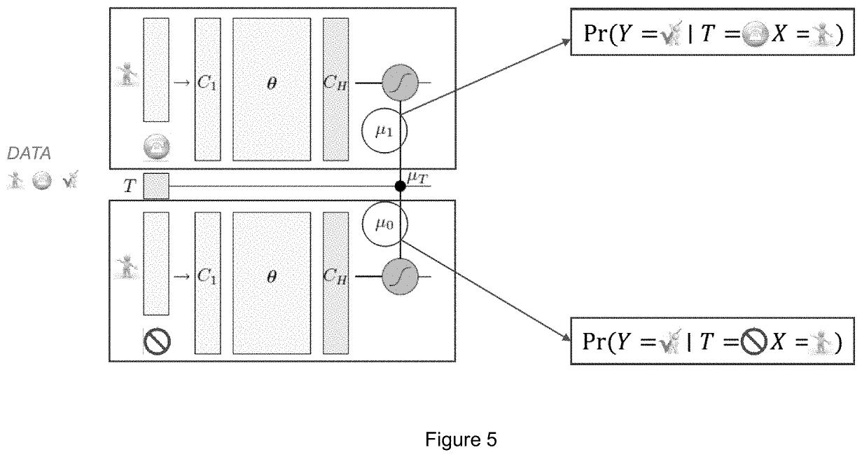

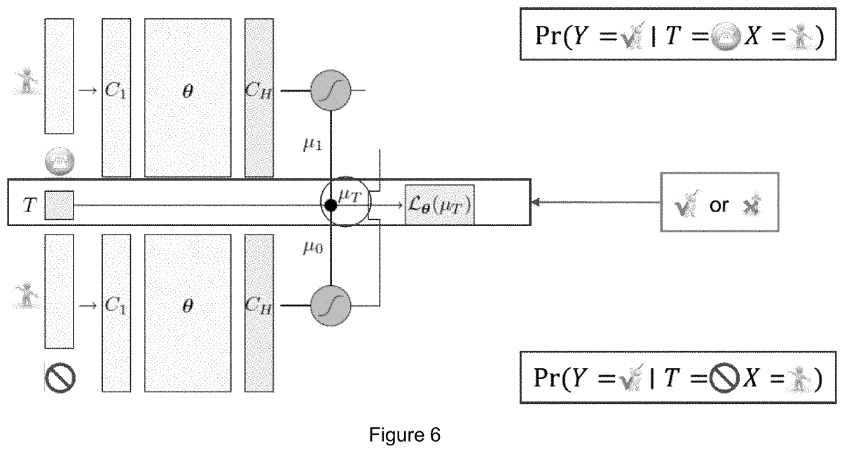

In at least some aspects, the Siamese neural network used in the Siamese machine learning model 114 (e.g. SMITE architecture) is a 6-layer feed forward machine learning neural network architecture multilayer perceptron (MLP). See also FIG. 3. The Siamese machine learning model 114 uses both a dataset featuring potential targets for the intervention, as well as a synthetic dataset. The Siamese machine learning model 114 may start with a list of targets who have either received or not received the targeted treatment. This list makes up the database from which the inputs for the model are derived, and it contains information about the customers such as their insurance information, including age, car type, where they live, how they behave, gender, etc. (e.g., data warehouse repository 102). The Siamese machine learning model 114 (e.g. SMITE) architecture involves a Siamese neural network model in which a target user in track A has received the targeted treatment, and the exact same target in track B has not received the treatment. See FIGS. 3, 5 and 6 for examples. The Siamese neural network shown as Siamese machine learning model 114 also knows the truth (T) about whether that particular target or customer did receive the targeted treatment. The truth makes up the control gate that determines which track goes further. The control gate checks if the prediction is correct then uses back propagation to correct that clause for training purposes of the model. An example schematic implementation of the Siamese machine-learning model 114 being a predictive model that has an iterative learning process and is flexible enough to predict different outcomes and to take into account the uplift prediction to guess whether or not the client received the treatment is illustrated in FIGS. 5 and 6.

In at least some aspects, in the output of the two tracks, the Siamese neural network shown as the Siamese machine learning model 114 provides a prediction of an uplift variable as described herein whereby the uplift may be defined as a distance between the predicted uplift and the transformed outcome. In at least some aspects, uplift is the probability of being “positive” while being treated minus the probability of being “positive” without being treated. The uplift therefore captures, in at least some aspects, the benefit to the determination of whether to perform the treatment. If, for example, first track A (the target when treated) yields a 90% chance of performing a desired action, and second track B (the target when not treated) yields a 50% chance of performing the action, then the uplift is 0.4 (0.9-0.5). If the uplift is positive then the target is considered persuadable (as in the example above). When the uplift is close to zero then the target is either a lost cause or a sure thing—the Siamese neural network 114 may not distinguish between these two, as the result in both is that it is not worth it to contact the customer. Where the uplift is negative then the target may fall into the do-not-disturb category, as the chances of them performing a desired action are higher when not contacted versus when contacted.

Conveniently, one example advantage that the Siamese neural network provided in the Siamese machine learning model 114 provides is that the track that does not correlate to the truth (whether or not the target actually did receive the treatment) can still be used to determine how well the model 114 captures the homogeneity. Whereas most models may at best focus on only one of: providing a good prediction or a heterogeneous prediction, those two rarely go hand in hand. Notably, SMITE model provided in the Siamese machine learning model 114 is able to improve upon past machine learning architectures and results by making both a good and a heterogeneous prediction.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the disclosure as defined in the claims.

1. A computer-implemented method comprising executing on a processor one or more steps comprising:
obtaining a dataset corresponding to a prediction task;
performing, via a randomizer, a random selection of whether to apply an artificial neural network comprising a Siamese neural network model to the dataset or whether to perform a random prediction for the prediction task;
determining subsequent to the random selection of the randomizer, a gathered outcome for each prediction scenario based on applying or not applying the model to the dataset including a difference between the gathered outcome for each scenario; and
feeding back the gathered outcome and the difference to retrain the Siamese neural network model for use in performing the prediction task.

2. The method of claim 1, wherein feeding back the gathered outcome further comprises performing a comparison of whether the gathered outcome aligns with a predefined expected outcome for applying or not applying the model as previously used to train the Siamese neural network model.

3. The method of claim 1, further comprising, further obtaining output data from the retrained model as input data to the randomizer for applying the retrained model in a subsequent iteration of the randomizer when the random selection indicates applying the model and generating a further gathered outcome to further retrain the model.

4. The method of claim 3, wherein the dataset comprises data obtained from a data warehouse and online data obtained from at least one website operating web content displays in response to the prediction task.

5. The method of claim 1, wherein the prediction task comprises whether to trigger a computing device to display information on an e-commerce website relating to a particular product offered on the e-commerce website and each Siamese neural network model is trained configured to perform a prediction for each type of product.

6. The method of claim 1, wherein the prediction task comprises whether to trigger a computing device to place an automated call relating to a particular product offered on an e-commerce website.

7. The method of claim 4, wherein, the Siamese neural network model performs the prediction task and further comprises:
receiving a set of inputs from an information bank detailing specific information in relation to one or more targets of a proposed treatment, this information bank containing results of a prior trial whereby some of the targets who are included in the information bank have already received the proposed treatment, and their response to said proposed treatment is included in the information bank;
executing a simultaneous simulation whereby the set of inputs are identically fed into a set of two tracks with an exception of one variable added to one track and not the other, this simulation also including a third track that represents a truth characterizing whether a particular target had received the proposed treatment in the trial and a corresponding response to the treatment;
automatically predicting, using the Siamese neural network, an uplift assessment based on uplift modelling of a difference in output between the two tracks; and,
in response to the uplift assessment generating, in real-time, a determination of whether the proposed treatment would have an expected effect on the particular target of the proposed treatment.

8. The method of claim 1 wherein the randomizer is performed using a network shared across multiple prediction tasks.

9. The method of claim 1, wherein one or more inputs to the dataset are randomly selected by the randomizer.

10. A computing device comprising a processor and a memory storing instructions that when executed by the processor cause the computing device to:
obtain a dataset corresponding to a prediction task;
perform, via a randomizer, a random selection of whether to apply an artificial neural network comprising a Siamese neural network model to the dataset or whether to perform a random prediction for the prediction task;
determine subsequent to the random selection of the randomizer, a gathered outcome for each prediction scenario based on applying or not applying the model to the dataset including a difference between the gathered outcome for each scenario; and,
feed back the gathered outcome and the difference to retrain the Siamese neural network model for use in performing the prediction task.

11. The computing device of claim 10, wherein feeding back the gathered outcome further comprises performing a comparison of whether the gathered outcome aligns with a predefined expected outcome for applying or not applying the model as previously used to train the Siamese neural network model.

12. The computing device of claim 10, wherein the instructions cause the computing device to further obtain output data from the retrained model as input data to the randomizer for applying the retrained model in a subsequent iteration of the randomizer when the random selection indicates applying the model and generating a further gathered outcome to further retrain the model.

13. The computing device of claim 12, wherein the dataset comprises data obtained from a data warehouse and online data obtained from at least one website operating web content displays in response to the prediction task.

14. The computing device of claim 10, wherein the prediction task comprises whether to trigger a computing device to display information on an e-commerce website relating to a particular product offered on the e-commerce website and each Siamese neural network model is trained configured to perform a prediction for each type of product.

15. The computing device of claim 10, wherein the prediction task comprises whether to trigger a computing device to place an automated call relating to a particular product offered on an e-commerce website.

16. The computing device of claim 13, wherein, the Siamese neural network model performs the prediction task, and the instructions further cause the computing device to perform the prediction task by:
receiving a set of inputs from an information bank detailing specific information in relation to one or more targets of a proposed treatment, this information bank containing results of a prior trial whereby some of the targets who are included in the information bank have already received the proposed treatment, and their response to said proposed treatment is included in the information bank;
executing a simultaneous simulation whereby the set of inputs are identically fed into a set of two tracks with an exception of one variable added to one track and not the other, this simulation also including a third track that represents a truth characterizing whether a particular target had received the treatment in the trial and a corresponding response to the treatment;
automatically predicting, using the Siamese neural network, an uplift assessment based on uplift modelling of a difference in output between the two tracks; and,
in response to the uplift assessment generating, in real-time, a determination of whether the proposed treatment would have an expected effect on the particular target of the proposed treatment.

17. The computing device of claim 10, wherein the randomizer is performed using a network shared across multiple prediction tasks.

18. The computing device of claim 10, wherein one or more inputs to the dataset are randomly selected by the randomizer.

19. The computing device of claim 12, wherein the memory communicatively coupled to the processor is configured for storing the gathered outcome, the difference and the output data from the retrained model.

20. A computer program product comprising a non-transient storage device storing instructions that when executed by at least one processor of a computing device, configure the computing device to:
obtain a dataset corresponding to a prediction task;
perform, via a randomizer, a random selection of whether to apply an artificial neural network comprising a Siamese neural network model to the dataset or whether to perform a random prediction for the prediction task;
determine subsequent to the random selection of the randomizer, a gathered outcome for each prediction scenario based on applying or not applying the model to the dataset including a difference between the gathered outcome for each scenario; and
feed back the gathered outcome and the difference to retrain the Siamese neural network model for use in performing the prediction task.
